(19) United States
(12) Patent Application Publication
(10) Pub. No.: US 2020/0030854 A1
(43) Pub. Date: Jan. 30, 2020

(54) Sorting Apparatus and Related Methods

(71) Applicant: KEY TECHNOLOGY, INC., WALLA WALLA, WA (US)

(72) Inventors: Johan Calcoen, WILSE-PUTKAPEL (LEUVEN) (BE); Peter Stulens, ZUTENDAAL (BE)

(21) Appl. No.: 16/589,825

(22) Filed: Oct. 1, 2019

Related U.S. Application Data
(63) Continuation-in-part of application No. 15/634,137, filed on Jun. 27, 2017, now Pat. No. 10,449,573.

(51) Int. Cl. B07C 5/342; G01N 21/89; F28F 27/00

(52) U.S. Cl. CPC B07C 5/342; F28F 27/00; G01N 21/8901

(57) ABSTRACT

A sorting apparatus, system, and related methods are described and which include a selectively heated avalanche photodiode (APD) which is maintained at a stable and substantially constant predetermined temperature and which further demonstrates a higher gain and signal-to-noise ratio with greater stability at the predetermined temperature for enhancing sorting efficiency.

### RELATED APPLICATIONS

This application is a Continuation In Part (CIP) of co-pending U.S. patent application Ser. No. 15/634,137, filed Jun. 27, 2017, entitled “Sorting Apparatus,” which is incorporated herein by reference.

### TECHNICAL FIELD

The present invention relates to a sorting apparatus, and more specifically to a sorting apparatus which utilizes an avalanche photodiode (APD), and which is further selectively maintained at one of a plurality of predetermined temperatures, and which demonstrates a higher gain and signal-to-noise ratio with greater stability, during operation.

### BACKGROUND OF THE INVENTION

The manufacturers of high speed, mass-flow food sorting devices have continually endeavored to develop devices, and related systems to readily identify acceptable and unacceptable objects or products travelling within a stream of products to be sorted, thus allowing a sorting apparatus to identify, and then remove, undesirable objects so as to produce a homogeneous, resulting product stream which is more useful for food processors, and/or other end users. Heretofore, attempts which have been made to enhance the ability to image objects effectively, in real time, have met with somewhat limited success.

While many advancements have been made in this technology area, there remains a long felt need to increase the ability for these previous sorting devices to detect electromagnetic radiation in selected bands such as in the near infrared spectrum as well as increase the sensitivity of detectors which detect, for example, red light and also emissions such as fluorescence which may be emitted by chlorophyll which is present in in various varieties of agricultural products which are being inspected.

While the use of prior art photomultiplier tubes to detect electromagnetic radiation have worked with some degree of success, it has long been recognized that photomultiplier tubes also display high noise or interference in the electrical signals that they generate. Still further, the bandwidth within which the typical photomultiplier tubes operate is considered relatively large. Consequently, developers of the aforementioned prior art sorting devices have sought an alternative to the use of photomultiplier tubes, and which may be useful in detecting the aforementioned bands of light in a manner not possible, heretofore. A sorting apparatus which avoids the detriments associated with the various prior art teachings and practices previously used in the art, is the subject matter of the present application.

### SUMMARY OF THE INVENTION

A first aspect of the present invention relates to a sorting apparatus which includes an inspection station for receiving a product stream which is to be sorted; an electromagnetic radiation assembly positioned adjacent to the inspection station, and which, when energized, generates a predetermined band of electromagnetic radiation, and which further is emitted in the direction of the inspection station, and wherein the emitted electromagnetic radiation is reflected, at least in part, from the product stream passing through the inspection station; an electromagnetic radiation detector for detecting the electromagnetic radiation which is emitted by the electromagnetic radiation assembly, and wherein the electromagnetic radiation detector includes an avalanche photodiode (APD) which is selectively maintained at one of a plurality of predetermined temperatures, and which further demonstrates a higher gain, and signal-to-noise ratio with greater stability at the selected predetermined temperature; and a controller operably and controllably coupled to each of the electromagnetic radiation assembly, and detector, respectively.

Still another aspect of the present invention relates to a sorting apparatus which includes an inspection station for receiving a product stream which is to be sorted; an electromagnetic radiation assembly positioned adjacent to the inspection station, and which, when energized, generates a predetermined band of electromagnetic radiation, and which further is emitted in the direction of the inspection station, and wherein the emitted electromagnetic radiation is reflected, at least in part, from the product stream passing through the inspection station; an electromagnetic radiation detector for detecting the electromagnetic radiation which is emitted by the electromagnetic radiation assembly, and wherein the electromagnetic radiation detector includes a selectively heated avalanche photodiode (APD) which is selectively maintained at one of a plurality of predetermined substantially constant temperatures, each of which is higher than a corresponding maximum ambient temperature threshold, and which further demonstrates a higher gain, and signal-to-noise ratio, with greater stability at the selected predetermined substantially constant temperature, and wherein the APD is made integral with a printed circuit board having top and bottom surfaces. A first layer of a heat conductive material is deposited on the top surface of the printed circuit board. A heat adjustment apparatus is operably mounted on the first layer of heat conductive material, and is selectively energized. In some embodiments the heat adjustment apparatus includes electrical componentry such as a transistor, diode, and/or resistor. In some embodiments, the heat adjustment apparatus, when selectively energized, generates heat energy which is received, and conductively transmitted by the first layer of heat conductive material. Vias are formed in the printed circuit board and extend between the top and bottom surfaces of the printed circuit board. The first layer of heat conductive material extends through the vias and transmits the generated heat energy, at least in part, to the bottom surface. The APD is mounted on the bottom surface of the printed circuit board and the heat energy generated by the heat adjustment apparatus is conductively transmitted, through the vias, to the APD. A temperature sensor is mounted in heat sensing relation relative to the second layer of heat conductive material. An electrical circuit is operably, and controllably coupled with each of the heat adjustment apparatus and the temperature sensor. The electrical circuit selectively, electrically energizes the heat adjustment apparatus so as to cause the heat adjustment apparatus to generate a sufficient amount of heat energy which is imparted to the first layer of heat conducting material, and then conductively transmitted to the second layer of heat conducting material, and which maintains the APD at the selected predetermined substantially constant temperature which is greater than a corresponding maximum ambient temperature threshold. A controller is operably and controllably coupled to each of the electromagnetic radiation assembly, APD, temperature sensor, and electrical circuit, respectively. Although the above-described embodiment of the present invention is described in terms of a printed circuit board, a person of ordinary skill in the art will appreciate that other forms of electronic circuitry are available and known in the art and may be used in place of the printed circuit board.

### BRIEF DESCRIPTION OF THE DRAWINGS

Preferred embodiments of the invention are described below, with reference to the following accompanying drawings.

FIG. 1 is a greatly simplified, partial, schematic view of a sorting apparatus employing the present invention.

FIG. 2 is a greatly simplified, schematic view of the present invention employing a fiber optic conduit, and which is coupled to a prior art laser scanner, and with an APD as described in the present invention.

FIG. 3 is a greatly simplified, schematic view of an arrangement where a fiber optic conduit is coupled in operable combination with an APD by using a collimated space, and which is located between the fiber optic cable and the APD.

FIG. 4 is a greatly simplified, schematic view showing a fiber optic conduit coupled in operable combination with an APD, and by means of a free-space located between the fiber optic cable or conduit, and the APD.

FIG. 5 is a greatly exaggerated, transverse, sectional view taken through a printed circuit board showing some of the features of the present invention.

FIG. 6 is a greatly simplified, schematic view of an electrical circuit which finds usefulness in the present invention.

FIG. 7 is a greatly simplified, partial, schematic view of another embodiment of a sorting apparatus employing the present invention.

FIG. 8 is a greatly simplified, partial, schematic view of another embodiment of a sorting apparatus employing the present invention.

FIG. 9 is a greatly simplified, partial, schematic view of another embodiment of a sorting apparatus employing the present invention.

FIG. 10 is a greatly simplified, partial, schematic view of another embodiment of a sorting apparatus employing the present invention.

FIG. 11 is a greatly simplified, partial, schematic view of another embodiment of a sorting apparatus employing the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

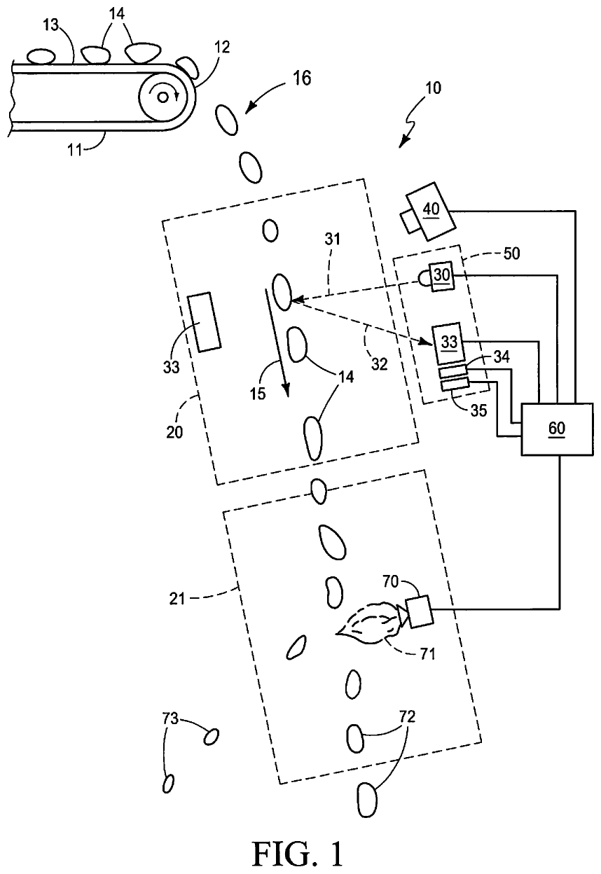

The sorting apparatus of the present invention is generally indicated by the numeral 10 in FIG. 1, and following. In this regard, and referring now to FIG. 1, the sorting apparatus 10 is generally depicted in this greatly simplified, schematic view. The sorting apparatus 10 includes a conveying device which is generally indicated by the numeral 11. The conveying device 11 has a distal end 12. Still further, the conveying device has an upwardly facing supporting surface 13, and which supports objects of interest and/or products to be inspected and sorted, 14, and which are further released for travel, under the influence of gravity, on a downwardly directed path of travel 15. The downwardly directed path of travel passes or moves through an inspection station 20, and a further, downstream, defect removal station which is generally indicated by the numeral 21. Although FIG. 1 depicts a conveying device 11, other embodiments of the present invention do not include a conveying device 11. For example, some embodiments of the present invention include a chute to direct the product stream 16 into the inspection station 20.

The product stream 16 which is traveling along the downwardly directed path of travel 15, moves or passes by, an electromagnetic radiation generation assembly which is generally indicated by the numeral 30. This assembly is further located laterally, outwardly relative to both the inspection station 20, and the product stream 14 which is moving along the path of travel 15. The electromagnetic radiation generation assembly, when energized, generates a predetermined band of electromagnetic radiation 31, and which further is emitted in the direction of the inspection station 20. The emitted electromagnetic radiation 31 is further reflected, at least in part, from the objects of interest or products 14 which are moving along in the product stream 16, and which are further passing through the inspection station 20. It should be understood that the emitted electromagnetic radiation 31 is reflected 32, at least in part, from the product stream 16 passing through the inspection station 20. The sorting apparatus 10 also includes an electromagnetic radiation detector 33 for detecting the electromagnetic radiation 31 and 32 which is emitted by the electromagnetic radiation assembly 30 and reflected 32, at least in part, from the product stream 16 passing through the inspection station 20. In the present invention, the electromagnetic radiation detector 33 includes an avalanche photodiode (APD) 34 which is selectively maintained at one of a plurality of predetermined APD temperature settings, and which further demonstrates, during operation, a higher gain, and signal-to-noise ratio with greater stability at the selected predetermined APD temperature setting.

Maintaining the APD 34 at a substantially constant temperature has many benefits that are well understood and documented in the prior art. The present invention capitalizes on the benefits of a substantially constant APD temperature, but adds new efficiencies and flexibility by providing a plurality of APD temperature settings, each of which is stable and substantially constant. This adds a new ability to increase or decrease the temperature of the APD 34, while retaining the benefits of the stable and substantially constant APD temperature at each of the APD temperature settings. In the present invention, the APD 34 is selectively heated to one of the plurality of predetermined APD temperature settings, as discussed, below. However, it is possible that the APD 34 could be cooled, or reduced in temperature (relative to the surrounding ambient temperature) to achieve the same stable and substantially constant APD temperature which is desired. This cooling, if implemented, has sufficient cooling capacity so as to maintain the APD 34 at the selected predetermined APD temperature setting which provides the higher gain, and signal-to-noise ratio desired. The sorting apparatus 10 may also include an image capturing device 40, of conventional design, and which is further operable to generate images of the individual objects of interest or products 14 that are moving along in the product stream 16, and which are further passing through the inspection station 20. The electromagnetic radiation generation assembly 30, as well as the electromagnetic radiation detector 33, the APD 34, and a photomultiplier tube (PMT) 35 may optionally be combined into a laser scanner which is generally indicated by the numeral 50. The laser scanner 50 when rendered operable generates an emitted beam of electromagnetic radiation 31 that moves along a given path of travel (not shown) through the inspection station 20 so as to optically inspect the individual objects of interest or products 14 which are passing through the inspection station 20. As seen in FIG. 1, the electromagnetic radiation generation assembly 30, the electromagnetic radiation detector 33, which in the present invention takes on the form of the APD 34 and optionally PMT 35, are each controllably coupled to a controller, and which is generally indicated by the numeral 60. The controller 60 synchronously operates the aforementioned components so as to optically interrogate the individual objects of interest or products 14 which are passing through the inspection station 20. The controller 60 is operably controllably coupled to a prior art ejector, and which is generally indicated by the numeral 70. The ejector typically takes on the form of a selectively operable air manifold. The ejector 70 is provided with an electrical signal from the controller 60 so as to release a source of pressurized air 71 which is effective in deflecting or propelling objects of interest or products 14 which are traveling in the product stream 16, out of the product stream, so that unacceptable objects of interest or products are removed. This action of the ejector 70 forms a resulting acceptable product stream 72, and an unacceptable product stream, and which is generally indicated by the numeral 73.

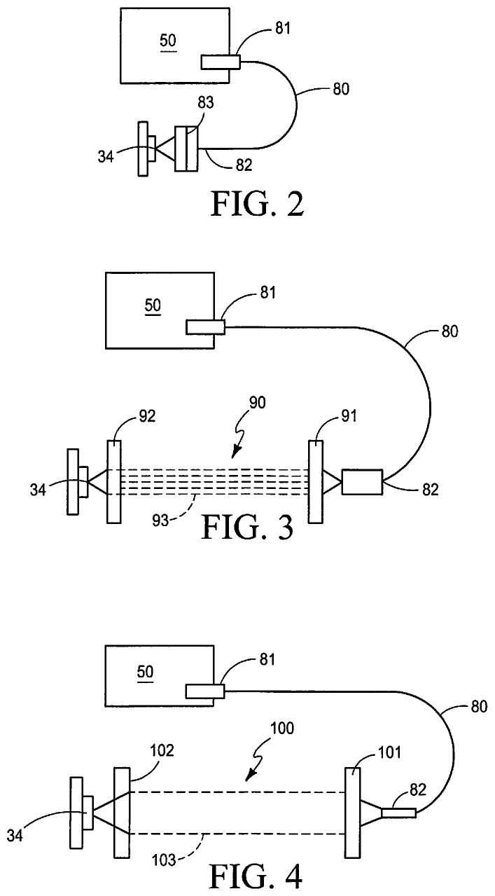

In some embodiments, the sorting apparatus 10, of the present invention, and as noted above, includes an APD 34, and which is optically coupled to a laser scanner 50. As seen in FIG. 2, and in one form of the invention, this optical coupling of the APD 34 to the laser scanner 50 may be achieved by a fiber optic conduit 80. The fiber optic conduit has a first end 81 which is received, and operably coupled to the laser scanner 50, and an opposite, second end 82, and which is further disposed in optical transmitting relation relative to a suitable optical element 83. The optical element 83 receives the emitted electromagnetic radiation 31, and then further projects it, or otherwise directs it onto an operable surface of the APD 34.

In a second form of the invention, the APD 34 is optically coupled to a collimated space 90 which is established between the APD 34, and the laser scanner 50. This is best seen by reference to FIG. 3. In this regard the fiber optic conduit 80, and more specifically the second end 82, thereof, is positioned in optical transmitting relation relative to a first optical element 91. The first optical element 91 then transmits or otherwise passes the emitted electromagnetic radiation 31, in a collimated beam 93 which is then received by a second optical element 92, and which is spaced a given distance from the first optical element 91. The second optical element 92, again, passes the emitted electromagnetic radiation 31, and then focuses or otherwise directs the emitted electromagnetic radiation onto an operational surface the APD 34. The emitted electromagnetic radiation which is collimated, and passed between the first and second optical elements 91 and 92, is indicated by the numeral 93 in FIG. 3.

In one possible form of the invention, not shown, one or more dichroic optical filters, (not shown) and which could be placed in the collimated beam 93, and then be rendered operable to select desired wavelengths of electromagnetic radiation in the collimated beam, and which would send the selected wavelengths of electromagnetic radiation onto one or more other APDs 34. Further the laser scanner may be optically coupled to the APD 34 by way of a free space transmission (FIG. 4), and which is generally indicated by the numeral 100. Again, the fiber optic conduit 80, and more specifically the second end 82, is positioned in optical transmitting relation relative to a first optical element 101. The first optical element 101 passes or transmits the emitted electromagnetic radiation to a second optical element 102. The emitted electromagnetic radiation 103 which passes between the first and second optical elements 101 and 102 is indicated by the numeral 103. Free space transmission is well known in the art. Again, the second optical element 102 focuses or otherwise passes the emitted electromagnetic radiation 103, and directs it onto an operational surface of the APD 34.

As noted above, in some embodiments of the present invention 10, the selectively heated avalanche photodiode (APD) 34 is selectively maintained at one of a plurality of predetermined APD temperature settings and which, when maintained at that predetermined APD temperature setting, demonstrates or produces a higher gain, and signal-to-noise ratio, with greater stability, at the selected predetermined APD temperature setting. More specifically, each of the plurality of predetermined APD temperature settings is stable, substantially constant, and elevated above a corresponding predetermined maximum ambient temperature threshold.

Although several examples are discussed below, the present invention is not limited to the following examples or other examples disclosed and discussed herein. In the following examples and throughout other examples disclosed and discussed herein, the predetermined APD temperature setting is selected dependent upon, and in some cases automatically and instantly reactive to, the measured ambient temperature. The predetermined APD temperature setting can be selected to be closer to the maximum ambient temperature threshold than is possible with prior art sorting machines and can be adjusted if the maximum ambient temperature threshold changes over time. Thus, the present invention can adjust over time to become more efficient.

### Example 1

For example, in some embodiments, as long as the measured ambient temperature does not differ by more than an acceptable amount from the predetermined maximum ambient temperature threshold of 40° C., the predetermined APD temperature setting is selected to be 43.5° C. and the APD 34 is heated and/or cooled to maintain the measured temperature of the APD 34 at a substantially constant temperature of 43.5° C., or within an acceptable narrow range about 43.5° C.

### Example 2

In another example, as long as the measured ambient temperature does not differ by more than an acceptable amount from the predetermined maximum ambient temperature threshold of 28° C., the predetermined APD temperature setting is selected to be 36° C. and the APD 34 is heated and/or cooled to maintain the measured temperature of the APD 34 at a substantially constant temperature of 36° C., or within an acceptable narrow range about 36° C.

### Example 3

In another example, as long as the measured ambient temperature does not differ by more than an acceptable amount from the corresponding predetermined maximum ambient temperature of 20° C., the predetermined APD temperature setting is selected to be 28° C. and the APD 34 is heated and/or cooled to maintain the measured temperature of the APD 34 at a substantially constant temperature of 28° C., or within an acceptable narrow range about 28° C.

### Example 4

In another example, as long as the measured ambient temperature does not differ by more than an acceptable amount from the predetermined maximum ambient temperature threshold of 13° C., the predetermined APD temperature setting is selected to be 20° C. and the APD 34 is heated and/or cooled to maintain the measured temperature of the APD 34 at a substantially constant temperature of 20° C., or within an acceptable narrow range about 20° C.

In the examples described above and throughout, if the measured ambient temperature differs from the predetermined maximum ambient temperature threshold by more than an acceptable amount, then a new, different one of the plurality of predetermined APD temperature setting is selected and the APD 34 is heated and/or cooled until the measured temperature of the APD 34 is stable and substantially constant at the new predetermined APD temperature setting, or within an acceptable narrow range about the new predetermined APD temperature setting. In some cases, if the measured ambient temperature remains lower than the predetermined maximum ambient temperature threshold by a predetermined amount for a predetermined period of time, then a new, different one of the plurality of predetermined APD temperature setting is selected and the APD 34 is heated and/or cooled until the measured temperature of the APD 34 is stable and substantially constant at the new predetermined APD temperature setting, or within an acceptable narrow range about the new predetermined APD temperature setting.

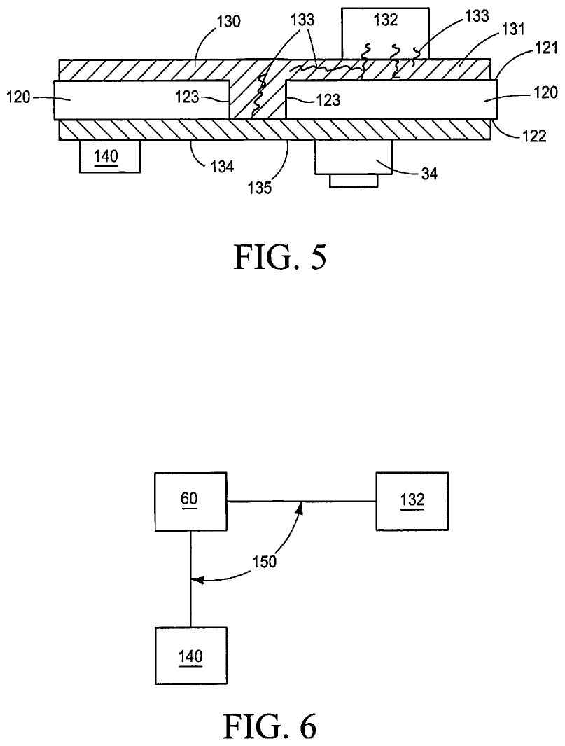

In some embodiments, the sorting apparatus 10 of the present invention, and which includes the APD 34, further has a printed circuit board 120, and which has top and bottom surfaces 121 and 122, respectively. Although the present invention is described in terms of a printed circuit board, a person of ordinary skill in the art will appreciate that other forms of electronic circuitry are available and known in the art and may be used in place of the printed circuit board. As seen in FIG. 5, at least one via or passageway 123 is formed in the printed circuit board, and further extends between the top and bottom surfaces 121 and 122, respectively. In addition to the foregoing, a first layer of a heat conducting material, such as copper, forming a heat sink, 130, is deposited or formed on the top surface 121, of the printed circuit board. The first layer of heat conducting material 130 covers a given portion of the top surface 121, and further extends, at least in part, through the at least one via or passageway 123, so as to communicate with the bottom surface 122. As illustrated in FIG. 5, a field effect transistor (FET) 132 is mounted on the top surface 131 of the first layer of heat conducting material 130, and which further operates as a heat sink 130. Although the present embodiment of the invention is described in terms of a field effect transistor (FET) 132, other components may be used in conjunction with or in place of the FET 132 to accomplish the function of heat transfer, such as resistors or diodes. The FET 132 is electrically coupled with an electrical control circuit. The FET 132 is operably mounted on the heat sink 130, and is further selectively energized by the electrical circuit so as to generate heat energy 133, and which further is received, and conductively transmitted by the heat sink 130. As noted, above, the first layer of heat conducting material forming the heat sink 130, extends, at least in part, through the vias 123, and further transmits the heat energy 133, at least in part, to the bottom surface 122 of the printed circuit board 120. The APD 34 is mounted or operably coupled to the bottom surface 122, and the heat energy generated by the field effect transistor 132 is conductively transmitted through the vias 123 to the APD 34, thereby maintaining the temperature of the APD 34 substantially constant. As seen in FIG. 5, a second layer of heat conducting material, such as copper, is deposited on the bottom surface 122 of the printed circuit body 120. The second layer of heat conducting material 134, and which forms a second heat sink, is coupled in heat receiving relation relative to the first layer of heat conducting material 130. Therefore, heat energy 133 which is transmitted into the first layer of heat conducting material 130 by the FET 132 is transmitted to the second layer of heat conducting material 134. As seen in FIG. 5, the APD 34 is mounted on, or otherwise coupled in heat receiving relation relative to the second layer of heat conducting material 134. The heat energy 133 which is provided by the FET 132 keeps the APD 34 at the selected predetermined temperature. The second layer of heat conducting material 134 has an outwardly facing surface 135, and which supports the APD 34, and other structures which will be discussed, below.

In some embodiments, the sorting apparatus 10 of the present invention further includes an APD temperature sensor 140 which is seen in the very simplified, schematic view of FIG. 6. The APD temperature sensor 140 is mounted, as seen in FIG. 5, in heat sensing relation relative to the second layer 134, of the heat conducting material, and which is deposited on the bottom surface 122, of the printed circuit board 120. Referring to FIG. 6, an electrical circuit 150, and which is operably coupled to the controller 60, is further operably coupled with each of the field effect transistor 132, and the APD temperature sensor 140. The electrical circuit 150 selectively, electrically energizes the transistor 132 so as to cause the transistor 132 to generate a sufficient amount of heat energy 133, and which is imparted to the first layer of heat conductive material 130, and which is subsequently conductively transmitted to the second layer of heat conducting material 134. The heat energy 133 maintains the APD 34 at the predetermined, elevated temperature noted, above. As indicated earlier, the field effect transistor 132 is typically mounted on the first heat conducting layer 130. Typically each of the heat conducting layers 130 and 134, are fabricated, at least in part, from copper. Further, the first and second layers of heat conducting material 130 and 134 are oriented so as to not be in heat conductive and/or transmitting relation relative to other assemblies that would be present in a typical laser scanner 50. The electrical circuit 150 is electrically coupled to and controlled by the controller 60 as seen in FIG. 6.

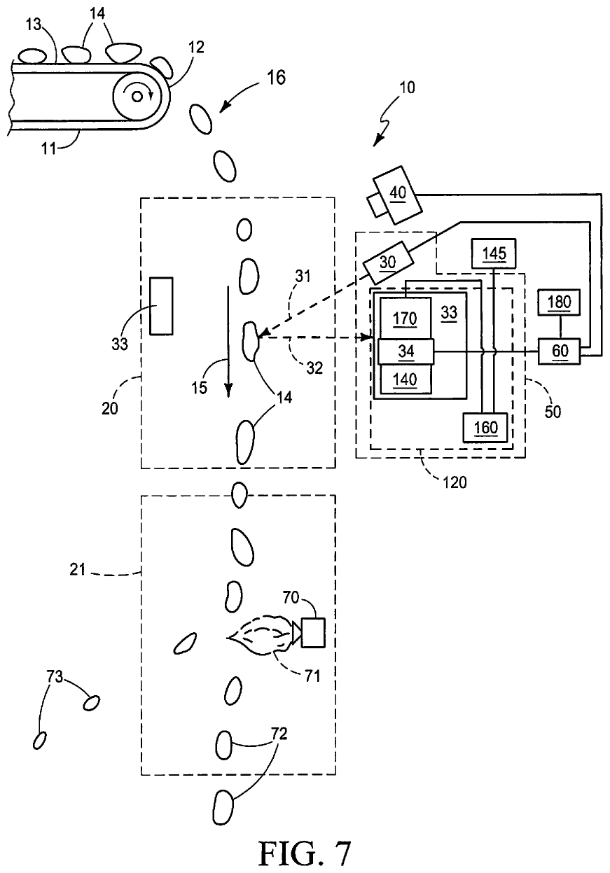

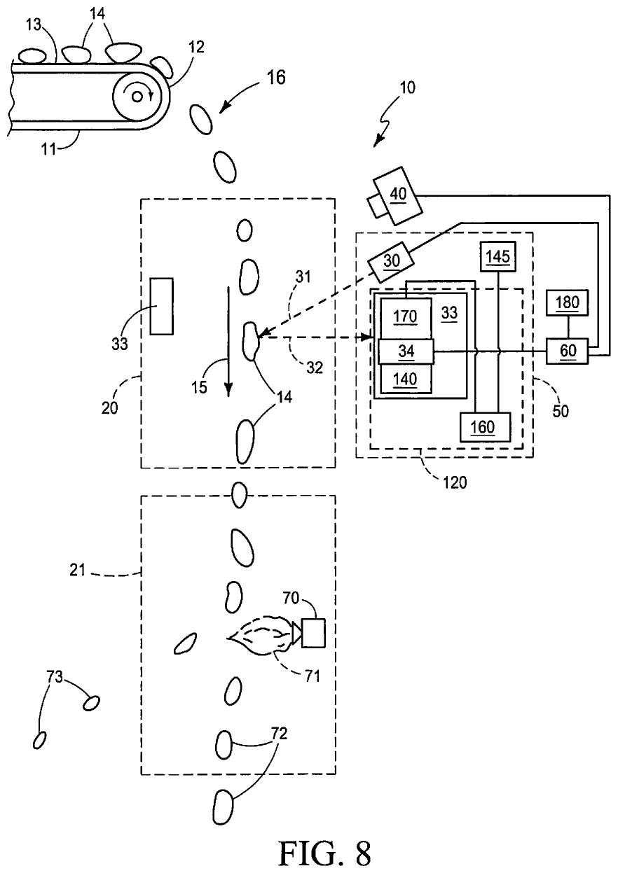

In some embodiments, as seen in FIG. 7, the sorting apparatus 10 of the present invention includes an electromagnetic radiation detector 33. The electromagnetic radiation detector 33 further includes an APD temperature sensor 140. The APD temperature sensor 140 is in heat sensing relation relative to the APD 34 to measure the temperature of the APD 34 in real time and on an ongoing continuous basis. In some embodiments, the APD temperature sensor is configured to measure the temperature of the APD 34 continually. The electromagnetic radiation detector 33 seen in FIG. 7 further includes a local computer based controller or microcontroller 160 operably connected to the APD temperature sensor 140 to continually or continuously monitor the measured temperature of the APD 34 and compare the measured temperature of the APD 34 to the selected predetermined APD temperature setting. The microcontroller 160 is operably and controllably connected to a heat adjustment apparatus 170. In some embodiments, the heat adjustment apparatus 170 is a heating element, such as FET 132. In some other embodiments, the heat adjustment apparatus 170 is a transistor, resistor, diode, Peltier device, thermoelectric cooler, heat sink, heat exchanger, cooling apparatus, or some combination of any of the above. The microcontroller 160 is configured to selectively engage or disengage the heat adjustment apparatus 170 to maintain the measured temperature of the APD 34 within an acceptable range of any one of the plurality of predetermined APD temperature settings. The sorting apparatus 10 seen in FIG. 7 further includes an ambient temperature sensor 145. The microcontroller 160 is operably connected to the ambient temperature sensor 145 to monitor the measured ambient temperature of the local environment and compare the measured ambient temperature to a maximum ambient temperature threshold. In some embodiments, seen in FIG. 7, the ambient temperature sensor 145 is located outside the laser scanner 50 and not in heat conductive and/or transmitting relation relative to the APD 34. In some embodiments, seen in FIG. 8, the ambient temperature sensor 145 is located within the laser scanner 50, but not in heat conductive and/or transmitting relation relative to the APD 34. In some embodiments, the ambient temperature sensor 145 is operably connected to the controller 60, but not directly to the microcontroller 160. In such embodiments, the controller 60 is operably coupled to the microcontroller 160 and the controller 60 and microcontroller 160 communicate back and forth information relating to ambient temperature, temperature control modes, conditions, commands, and/or instructions.

In some embodiments, as seen in FIGS. 7-8, the microcontroller 160 compares the measured temperature of the APD 34 to the measured ambient temperature and the selected predetermined APD temperature setting and is operably connected to a system executive computer 180 to send information to the system executive computer 180 regarding the comparison, the measured ambient temperature, the measured APD temperature, and status of the APD 34. In some embodiments, the microcontroller 160 is operably connected to the controller 60 which is operably connected to the system executive computer 180. In such embodiments the system executive computer 180 communicates with the microcontroller 160 via the controller 60. The microcontroller 160 is further configured to communicate back and forth with the controller 60 and the system executive computer 180 relating to conditions that affect the selection of one of the plurality of predetermined APD temperature settings. The microcontroller 160 selects one of the plurality of predetermined APD temperature settings depending upon measured APD 34 temperature, measured ambient temperature, predetermined maximum temperature threshold, and, in some cases, other conditions. The microcontroller 160 is configured to selectively engage or disengage the heat adjustment apparatus 170 to maintain the APD 34 at the selected predetermined APD temperature setting or within an acceptable narrow temperature range about the selected predetermined APD temperature setting. The microcontroller 160 is further configured to, under certain predetermined conditions, select a different one of the plurality of predetermined APD temperature settings and thus selectively engage or disengage the heat adjustment apparatus 170 to maintain the APD 34 at the different selected predetermined APD temperature setting or within an acceptable temperature range about the different selected predetermined APD temperature setting.

In some embodiments, the microcontroller 160 actively and continuously monitors and compares the measured ambient temperature to the maximum ambient temperature threshold and the measured APD temperature to the selected predetermined APD temperature setting. In some other embodiments, the microcontroller 160 continually monitors and compares the measured ambient temperature to the maximum ambient temperature threshold and the measured APD temperature to the selected predetermined APD temperature setting. In the event that the measured APD temperature differs from the selected predetermined APD temperature setting by more than an acceptable amount, the microcontroller 160 selectively engages or disengages the heat adjustment apparatus 170 until the measured temperature of the APD 34 returns to within an acceptable range about the selected predetermined APD temperature setting. In the event that the measured ambient temperature exceeds the maximum ambient temperature threshold or differs from the maximum ambient temperature threshold by more than an acceptable amount (e.g., measured ambient temperature too closely approaches, or falls too far below, the maximum ambient temperature threshold), the microcontroller 160 selects a different one of the plurality of predetermined APD temperature settings. When the measured ambient temperature is consistently below the maximum ambient temperature threshold for a predetermined period of time, the microcontroller 160 selects a different one of the plurality of predetermined APD temperature settings. In this manner, each of the plurality of predetermined APD temperature settings corresponds to a different one of the maximum ambient temperature thresholds. The system executive computer 180 communicates back and forth with the microcontroller 160, in some embodiments through the controller 60, relating to the predetermined maximum ambient temperature thresholds, predetermined periods of time, redetermined APD temperature settings, and other conditions. In this way, the system executive computer 180 and/or the controller 60 coordinate APD 34 signal processing commensurate with ambient and APD temperatures such that APD 34 signals are continually optimized for environmental and actual APD temperatures and conditions. Furthermore, in this way it is possible for the system executive computer 180 to select and communicate different modes of operation to the controller 60 and the microcontroller 160 so as to optimize and stabilize performance of APD 34.

Several additional examples are discussed below. The present invention is not limited to the following examples or other examples disclosed and discussed herein.

### Example 5

In some embodiments the microcontroller 160 is configured such that when the maximum ambient temperature threshold is 13° C., the selected predetermined APD temperature setting is 20° C. If the measured temperature of the APD 34 drops to 19° C. or colder, the heat adjustment apparatus is engaged until the measured temperature of the APD 34 returns to 20° C., or within an acceptable narrow range about 20° C. If the measured temperature of the APD is 21° C. or warmer, the heat adjustment apparatus is engaged or disengaged, as appropriate, until the measured temperature of the APD 34 returns to 20° C., or within an acceptable narrow range about 20° C. If the measured ambient temperature exceeds 13° C., but lower than 20° C., the predetermined APD temperature setting is changed to 28° C. and the corresponding maximum ambient temperature threshold is adjusted to 20° C.

### Example 6

In some embodiments the microcontroller 160 is configured such that when the maximum ambient temperature threshold is 20° C., the selected predetermined APD temperature setting is 28° C. If the measured temperature of the APD 34 drops to 27° C. or colder, the heat adjustment apparatus is engaged until the measured temperature of the APD 34 returns to 28° C., or within an acceptable narrow range about 28° C. If the measured temperature of the APD is 29° C. or warmer, the heat adjustment apparatus is engaged or disengaged, as appropriate, until the measured temperature of the APD 34 returns to 28° C., or within an acceptable narrow range about 28° C. If the measured ambient temperature exceeds 20° C., but lower than 28° C., the predetermined APD temperature setting is changed to 36° C. and the corresponding maximum ambient temperature threshold is adjusted to 28° C.

### Example 7

In some embodiments the microcontroller 160 is configured such that when the maximum ambient temperature threshold is 28° C., the selected predetermined APD temperature setting is 36° C. If the measured temperature of the APD 34 drops to 35° C. or colder, the heat adjustment apparatus is engaged until the measured temperature of the APD 34 returns to 36° C., or within an acceptable narrow range about 36° C. If the measured temperature of the APD is 37° C. or warmer, the heat adjustment apparatus is engaged or disengaged, as appropriate, until the measured temperature of the APD 34 returns to 36° C., or within an acceptable narrow range about 36° C. If the measured ambient temperature exceeds 28° C., but lower than 40° C., the predetermined APD temperature setting is changed to 43.5° C. and the corresponding maximum ambient temperature threshold is adjusted to 40° C.

### Example 8

In some embodiments the microcontroller 160 is configured such that when the maximum ambient temperature threshold is 40° C., the selected predetermined APD temperature setting is 43.5° C. If the measured temperature of the APD 34 drops to 43° C. or colder, the heat adjustment apparatus is engaged until the measured temperature of the APD 34 returns to 43.5° C., or within an acceptable narrow range about 43.5° C. If the measured temperature of the APD is 44° C. or warmer, the heat adjustment apparatus is engaged or disengaged, as appropriate, until the measured temperature of the APD 34 returns to 43.5° C., or within an acceptable narrow range about 43.5° C. If the measured ambient temperature exceeds 40° C., the sorting apparatus is beyond its functional operational temperature range.

### Example 9

In some embodiments, the microcontroller 160 is configured such that if the predetermined APD temperature setting is 43.5° C. and the ambient temperature is consistently measured at or below 28° C. for 6 hours (or some other predetermined period of time), the microcontroller 160 selects the predetermined APD temperature setting to be 36° C. and the corresponding maximum temperature threshold to be 28° C.

### Example 10

In some embodiments, the microcontroller 160 is configured such that if the predetermined APD temperature setting is 36° C. and the ambient temperature is consistently measured at or below 20° C. for 6 hours (or some other predetermined period of time), the microcontroller 160 selects the predetermined APD temperature setting to be 28° C. and the corresponding maximum temperature threshold to be 20° C.

### Example 11

In some embodiments, the microcontroller 160 is configured such that if the predetermined APD temperature setting is 28° C. and the ambient temperature is consistently measured at or below 13° C. for 6 hours (or some other predetermined period of time), the microcontroller 160 selects the predetermined APD temperature setting to be 20° C. and the corresponding maximum temperature threshold to be 13° C.

In other examples, the system executive computer 180 applies programming logic to adjust the conditions and settings and provides appropriate instructions to the microcontroller 160 and/or to the controller 60, which, in some embodiments, applies its own programming logic or conveys instructions from the system executive computer 180 to the microcontroller 160. In some examples, the temperature sensors 140 and 145 measure respective temperatures in 0.1° C. increments and the system executive computer 180 and microcontroller 160 and/or controller 60 make respective adjustments in 0.1° C. increments. Thus, the apparatus of the present invention has fine resolution and sensitivity down to 0.1° C.

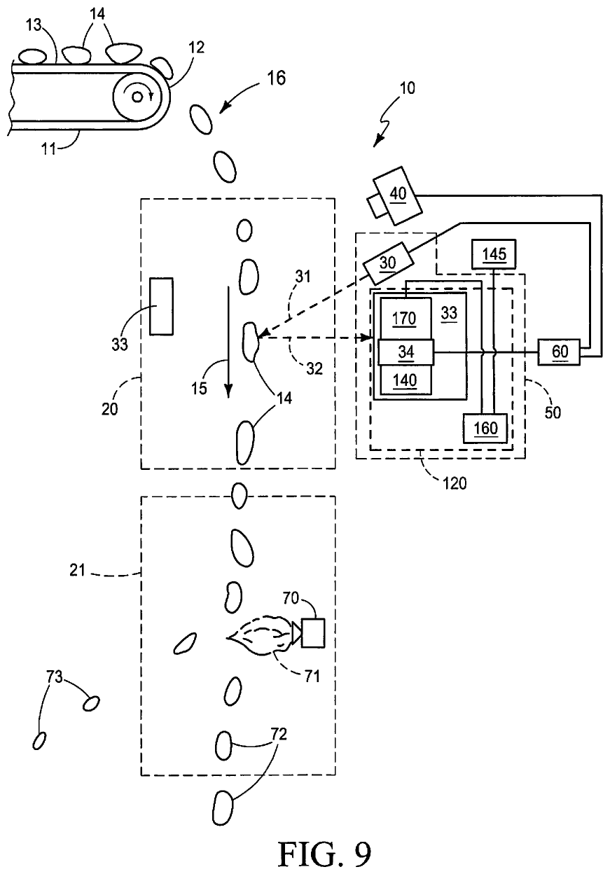

In some embodiments, as seen in FIGS. 7-9, the microcontroller 160 compares the measured temperature of the APD 34 to the measured ambient temperature and the predetermined APD temperature setting and maximum ambient temperature threshold and is operably connected to the controller 60 to send information back and forth with the controller 60 regarding the measured ambient temperature, the measured APD temperature, status of the APD 34, selected predetermined APD temperature setting, and selected maximum ambient temperature threshold. In some embodiments, the ambient temperature sensor 145 is operably connected to the controller 60 which provides ambient temperature information to one or more operably connected microcontroller 160 and APD 34. In the embodiment seen in FIG. 9, the controller 60 is configured to perform all of the functions of the system executive computer 180 discussed above. As discussed further above, the APD 34 is controllably coupled to the controller 60, which synchronously operates the APD 34 and other aforementioned components so as to optically interrogate the individual objects of interest or products 14 which are passing through the inspection station 20.

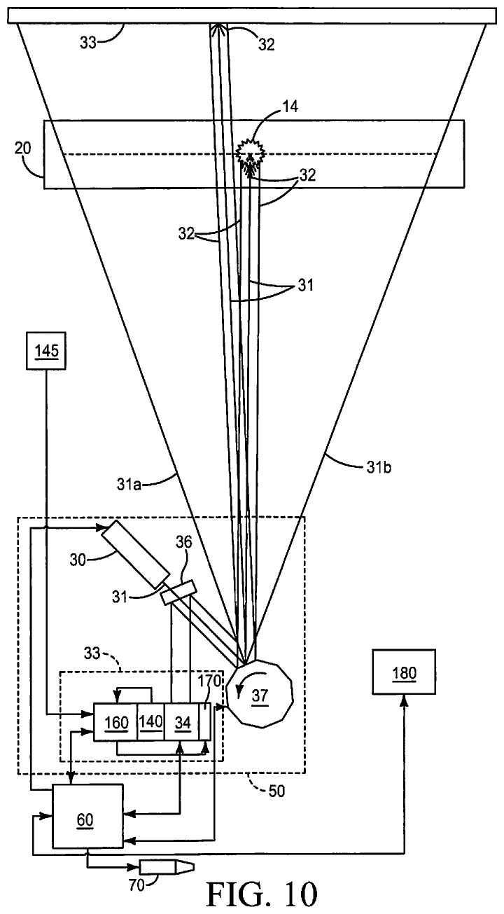

Another embodiment of a sorting apparatus of the present invention is shown in FIG. 10. The sorting apparatus shown in FIG. 10 is depicted as viewed from the top looking down. The sorting apparatus shown in FIG. 10 is similar to those described above and includes objects or products to be inspected and sorted, 14, and which are further released for travel, under the influence of gravity, on a path of travel generally extending along the viewer's line of sight toward and into the page, passing through the inspection station 20. The sorting apparatus includes an electromagnetic radiation generation assembly 30. The electromagnetic radiation generation assembly 30, when energized, generates a predetermined band of electromagnetic radiation 31. The electromagnetic radiation 31 passes through a one-way mirror or Pritchard mirror 36 and is directed toward the inspection station 20 by a rotating laser scanning polygon mirror 37. The rotating laser scanning polygon mirror 37 is configured to direct the electromagnetic radiation 31 on a moving path toward the inspection station that ranges from a left edge 31a to a right edge 31b. Thus, the sorting apparatus is configured such that the emitted electromagnetic radiation 31 scans the inspection station 20 along a width ranging from the left edge 31a to the right edge 31b. The emitted electromagnetic radiation 31 is reflected 32, at least in part, from the objects of interest or products 14 which are falling in the direction into the page, and which are further passing through the inspection station 20.

The sorting apparatus 10 also includes an electromagnetic radiation detector 33 for detecting the electromagnetic radiation 31 and 32 which is emitted by the electromagnetic radiation assembly 30 and reflected 32, at least in part, from the products 14 passing through the inspection station 20. The electromagnetic radiation detector 33 includes an avalanche photodiode (APD) 34 which is selectively maintained at one of a plurality of predetermined APD temperature settings, and which further demonstrates, during operation, a higher gain, and signal-to-noise ratio with greater stability at the selected predetermined APD temperature setting. Selectively maintaining the APD 34 at one of the plurality of predetermined temperature settings is as discussed above. In the sorting apparatus shown in FIG. 10, the electromagnetic radiation generation assembly 30, the one-way mirror 36, the rotating laser scanning polygon mirror 37, and the APD 34 are combined into a laser scanner 50. The laser scanner 50 further includes an APD temperature sensor 140, a microcontroller 160, and a heat adjustment apparatus 170, each of which has been discussed and described above. The laser scanner 50 when rendered operable generates an emitted beam of electromagnetic radiation 31 that moves along a given path of travel through the inspection station 20 so as to optically inspect the individual objects of interest or products 14 which are passing through the inspection station 20.

As seen in FIG. 10, the electromagnetic radiation generation assembly 30, the electromagnetic radiation detector 33, which in the present invention includes the APD 34, the microcontroller 160, and the rotating laser scanning polygon mirror 37 are each controllably coupled to a controller 60. The controller 60 synchronously operates the aforementioned components so as to optically interrogate the individual objects of interest or products 14 which are passing through the inspection station 20. The controller 60 is operably controllably coupled to a prior art ejector, and which is generally indicated by the numeral 70. The ejector 70 typically takes on the form of a selectively operable air manifold. The ejector 70 is provided with an electrical signal from the controller 60 so as to release a source of pressurized air which is effective in deflecting or propelling objects of interest or products 14 out of the product stream, so that unacceptable objects of interest or products are removed. As seen in FIG. 10, the sorting apparatus further includes an ambient temperature sensor 145 operably coupled to the microcontroller 160 such that the ambient temperature is measured and monitored continuously or continually.

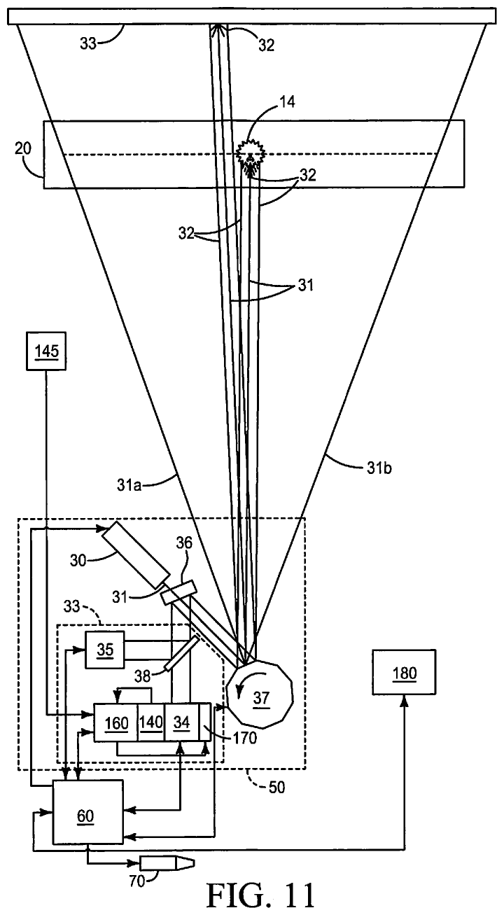

In FIG. 11, another embodiment of the sorting apparatus shown in FIG. 10 is provided. As seen in FIG. 11, the electromagnetic radiation detector 33 of the laser scanner 50 further includes a photomultiplier tube (PMT) 35 as discussed above. The sorting apparatus shown in FIG. 11 includes a dichroic filter or beam splitter 38 to distribute portions of the incoming reflected electromagnetic radiation 32 to the APD 34 and PMT 35.

In some embodiments (not shown), the electromagnetic radiation generation assembly 30 is not controllably coupled to the controller 60, but rather is configured to operate independent of the controller 60. In such embodiments, the electromagnetic radiation assembly is configured to operate at a constant output with no synchronization with the electromagnetic radiation detector 33. In such embodiments, the rotating laser scanning polygon mirror 37 is operably coupled to the controller 60 such that the mirror's position at any given time is synchronized with the electromagnetic radiation detector 33, which includes APD 34 and optionally PMT 35.

### Operation

The operation of the described embodiments of the present invention is believed to be readily apparent and is briefly summarized at this point.

In its broadest aspect the present invention relates to an electrical device which produces an electrical signal, and which is maintained at one of several possible stable and substantially constant predetermined temperatures, and which further demonstrates a higher gain, and signal-to-noise ratio with greater stability, at the selected, predetermined temperature, and which further is unaffected in its performance by a surrounding, environmental ambient temperature.

The sorting apparatus 10 of the present invention includes, as a first aspect an inspection station 20 for receiving a product stream 16 which is to be sorted. The sorting apparatus 10 further includes an electromagnetic radiation generating assembly 30 which is positioned adjacent to the inspection station 20, and which, when energized, generates a predetermined band of electromagnetic radiation 31, and which further is emitted in the direction of the inspection station 20. The emitted electromagnetic radiation 31 is reflected, at least in part, from the product stream 16 passing through the inspection station 20. The sorting apparatus 10 further includes an electromagnetic radiation detector 33 for detecting the electromagnetic radiation 31, and which is emitted by the electromagnetic radiation generating assembly 30. The electromagnetic radiation detector 33 includes, in one form of the invention, a selectively heated avalanche photodiode (APD) 34, and which is selectively maintained at one of a plurality of predetermined, substantially constant APD temperature settings, each of which is greater than a corresponding ambient temperature threshold. The APD 34 demonstrates a higher gain, and signal-to-noise ratio with greater stability, at each of the plurality of predetermined APD temperature settings. In some embodiments, the APD 34 is made integral with a printed circuit board 120 having top and bottom surfaces 121 and 122, respectively. A first layer of a heat conducting material 130 is deposited on the top surface 121 of the printed circuit board 120. A transistor 132 is operably mounted on the first layer of the heat conducting material 130, and is selectively energized. The transistor 132 when selectively energized generates heat energy 133, and which is received and then conductively transmitted by the first layer of heat conducting material 130, by way of the vias 123, and which are formed in the printed circuit board 120, to the bottom surface 122 of the printed circuit board 120. As seen in the drawings, the first layer of heat conductive material 130 extends through the vias 123, and transmits the generated heat energy 133, at least in part, to the bottom surface 122. Still further, the APD 34 is mounted on the bottom surface 122, of the circuit board 120, and the heat energy 133 which is generated by the transistor 130, is conductively transmitted through the vias 123 to the APD 34. The sorting apparatus 10 of the present invention includes an APD temperature sensor 140, and which is mounted in heat sensing relation relative to the second layer of heat conducting material 134, and which maintains the APD 34 at, or within an acceptable range of, the predetermined APD temperature setting which is greater than a selected one of a plurality of maximum ambient temperature thresholds. The sorting apparatus 10 further includes a controller 60 which is operably and controllably coupled to each of the electromagnetic radiation generating assembly, APD 34, APD temperature sensor 140, and electrical circuit 150, respectively. As earlier discussed, in some embodiments, the selected predetermined, substantially constant temperature of the APD is maintained at a temperature of substantially about 43.5° C. Further, the predetermined maximum ambient temperature threshold is selected to be 40° C. The sorting apparatus 10 of the present invention, in one form, further includes a photomultiplier tube (PMT) 35, which detects the electromagnetic radiation 31 which is emitted by the electromagnetic radiation generating assembly 30. In the present invention the APD 34 has a main body, and an electrical ground; and the electrical circuit 150 also has an electrical ground. In the arrangement as seen in the drawings, each of the aforementioned electrical grounds of the APD 34, and electrical circuit 150, are coupled to the body of the APD. In this arrangement the invention 10 operates in a manner where the noise generated by each of the APD 34, electrical circuit 150 is reduced, thereby enhancing the operation of the present invention.

In some embodiments, a larger system includes a plurality of the apparatus shown in FIG. 7 or 8, and the plurality of apparatus may be referred to as 10, 10′, 10″, . . . . Each apparatus 10, 10′, 10″, . . . includes its own APD 34, 34′, 34″, . . . and each APD 34, 34′, 34″, . . . includes its own APD temperature sensor 140, 140′, 140″, . . . , heat adjustment apparatus 170, 170′, 170″, . . . , and microcontroller 160, 160′, 160″, . . . . In this configuration, each microcontroller 160, 160′, 160″, . . . is operably connected to its respective APD temperature sensor 140, 140′, 140″, . . . and heat adjustment apparatus 170, 170′, 170″, . . . , as discussed above. However, in this configuration, each microcontroller 160, 160′, 160″, . . . is operably connected to one single system executive computer 180 and the system executive computer 180 collects information from all of the microcontrollers 160, 160′, 160″, . . . , analyzes all of the data and applies its programming logic, and communicates back and forth with each of the microcontrollers 160, 160′, 160″, . . . , separately. In some such configurations, each microcontroller 160, 160′, 160″, . . . is operably connected to its respective ambient temperature sensor 145, 145′, 145″, . . . . In other such configurations, each microcontroller 160, 160′, 160″, . . . is operably connected to one single ambient temperature sensor 145. In other such configurations, each microcontroller 160, 160′, 160″, . . . is operably connected to one single controller 60 which is operably connected to a single ambient temperature sensor 145 and further operably connected to the system executive computer 180. In such configurations the controller 60 provides ambient temperature information and system executive programming, modes, commands or instructions to each operably connected microcontroller 160, 160′, 160″, . . . .

The apparatus of the present invention is now “smart.” The microcontroller 160 and system executive computer 180, and in some configurations, the controller 60, experience bi-directional communication one with the other and each can be configured to “learn” from the data collected from the other. The information and data collected from each is run through programming logic and, in some instances, predictive analytics are applied to increase efficiencies, reduce costs, and/or improve productivity. The apparatus reaches operable temperature faster and over a wider range of ambient and APD temperatures.

In some aspects, the present invention relates to methods of manufacturing any of sorting apparatus 10 described above. The method includes providing an inspection station 20. The inspection station 20 is configured to receive the product stream 16 which is to be sorted. The method further includes providing an electromagnetic radiation generation assembly 30. The electromagnetic radiation assembly 30 is positioned adjacent to the inspection station 20. When energized, it generates a band of electromagnetic radiation 31 which is emitted in the direction of the inspection station 20. The emitted electromagnetic radiation is reflected 32, at least in part, from the product stream 16 passing through the inspection station 20. The method further includes providing an electromagnetic radiation detector 33 for detecting the electromagnetic radiation 31 which is emitted by the electromagnetic radiation assembly 30. The electromagnetic radiation detector 33 includes an avalanche photodiode (APD) 34 which is selectively maintained at one of a plurality of predetermined temperature settings. The method further includes providing a controller 60 operably and controllably connected to each of the electromagnetic radiation assembly 30 and detector 33, respectively. Optionally, the method further includes providing a photomultiplier tube (PMT) 35 which detects the electromagnetic radiation 31 emitted by the electromagnetic radiation assembly 30.

In some aspects, the present invention relates to methods of using any of the sorting apparatus 10 described above. The method includes selecting one of the plurality of predetermined APD temperature settings. The temperature of the APD 34 is measured by an APD temperature sensor 140. The measured APD temperature is compared to the selected predetermined APD temperature setting. The heat adjustment apparatus 170 is engaged and/or disengaged until the measured APD temperature is within an acceptable range about the selected predetermined APD temperature setting. In some aspects, the method further includes selecting one of a plurality of predetermined maximum ambient temperature thresholds. In some embodiments, each of the plurality of predetermined maximum ambient temperature thresholds corresponds to a different one of the plurality of predetermined APD temperature settings. The ambient temperature is measured. The measured ambient temperature is compared to the selected predetermined maximum ambient temperature threshold. When the measured ambient temperature differs from the selected predetermined maximum ambient temperature setting by more than an acceptable amount, a different one of the plurality of predetermined APD temperature settings and a corresponding different one of the predetermined maximum ambient temperature thresholds is selected. When the measured ambient temperature is consistently below a predetermined maximum ambient threshold for a predetermined period of time, a different one of the plurality of predetermined APD temperature settings and a corresponding different one of the predetermined maximum ambient temperature thresholds is selected. In some embodiments, the method further includes providing instructions to the microcontroller 160 relating to conditions under which the microcontroller 160 is to select a different one of the predetermined APD temperature settings and predetermined maximum ambient temperature thresholds.

Therefore, it will be seen that the present invention provides a convenient means whereby an automated, high-speed sorting apparatus can be rendered much more effective to detect selective bands of reflective electromagnetic radiation reflected from a product stream so as to allow the sorting apparatus to achieve sorting efficiencies and accuracies not possible heretofore.

In compliance with the statute the invention has been described in language more or less specific as so structural and methodical features. It is to be understood, however that the invention is not limited to the specific features shown and described since the means herein disclosed comprise preferred forms of putting the invention into effect. The invention is, therefore, claimed in any of its forms of modifications within the proper scope of the appended claims, appropriately interpreted in accordance with the Doctrine of Equivalence.

We claim:

1. A sorting apparatus comprising:
an inspection station for receiving a product stream which is to be sorted;
an electromagnetic radiation generation assembly positioned adjacent to the inspection station, and which, when energized, generates a predetermined band of electromagnetic radiation, and which further is emitted in the direction of the inspection station, and wherein the emitted electromagnetic radiation is reflected, at least in part, from the product stream passing through the inspection station;
an electromagnetic radiation detector for detecting the electromagnetic radiation which is emitted by the electromagnetic radiation assembly, and wherein the electromagnetic radiation detector includes an avalanche photodiode (APD) which is maintained at a predetermined temperature; and
a controller operably and controllably coupled to the electromagnetic radiation detector.

2. A sorting apparatus as claimed in claim 1, further comprising a photomultiplier tube (PMT) which detects the electromagnetic radiation emitted by the electromagnetic radiation assembly.

3. A method of manufacturing a sorting apparatus, the method comprising:
providing an inspection station configured to receive a product stream which is to be sorted;
providing an electromagnetic radiation assembly positioned adjacent to the inspection station, and which, when energized, generates a predetermined band of electromagnetic radiation, and which further is emitted in the direction of the inspection station, and wherein the emitted electromagnetic radiation is reflected, at least in part, from the product stream passing through the inspection station;
providing an electromagnetic radiation detector for detecting the electromagnetic radiation which is emitted by the electromagnetic radiation assembly, and wherein the electromagnetic radiation detector includes an avalanche photodiode (APD); which is maintained at a predetermined temperature; and
providing a controller operably and controllably coupled to the electromagnetic radiation detector.

4. A method as claimed in claim 3, further comprising:
providing a photomultiplier tube (PMT) which detects the electromagnetic radiation emitted by the electromagnetic radiation assembly.

5. A sorting apparatus comprising:
an inspection station for receiving a product stream which is to be sorted;
an electromagnetic radiation assembly positioned adjacent to the inspection station, and which, when energized, generates a predetermined band of electromagnetic radiation, and which further is emitted in the direction of the inspection station, and wherein the emitted electromagnetic radiation is reflected, at least in part, from the product stream passing through the inspection station;
an electromagnetic radiation detector for detecting the electromagnetic radiation which is emitted by the electromagnetic radiation assembly, and wherein the electromagnetic radiation detector includes an avalanche photodiode (APD) which is configured to be selectively maintained at one of a plurality of predetermined APD temperature settings;
a controller operably and controllably coupled to the electromagnetic radiation detector.

6. A sorting apparatus as claimed in claim 5, further comprising an APD temperature sensor in heat sensing relation relative to the APD and configured to measure the temperature of the APD.

7. A sorting apparatus as claimed in claim 6, further comprising a microcontroller operably connected to the APD temperature sensor and configured to monitor the measured temperature of the APD and compare the measured temperature of the APD to the selected predetermined APD temperature setting.

8. A sorting apparatus as claimed in claim 7, wherein the microcontroller is further operably and controllably connected to a heat adjustment apparatus, and wherein the microcontroller is configured to selectively engage or disengage the heat adjustment apparatus to adjust the temperature of the APD and to maintain the measured temperature of the APD within an acceptable predetermined range about the selected predetermined APD temperature setting.

9. A sorting apparatus as claimed in claim 8, further comprising an ambient temperature sensor configured to measure ambient temperature, but not in heat conductive or transmitting relation relative to the APD, and wherein the microcontroller is operably connected to the ambient temperature sensor and configured to monitor the measured ambient temperature and compare the measured ambient temperature to one of a plurality of predetermined maximum ambient temperature thresholds.

10. A sorting apparatus as claimed in claim 9, further comprising a system executive computer operably connected to the microcontroller via the controller, wherein the system executive computer is configured to send and receive information relating to the measured ambient temperature, the selected predetermined maximum ambient temperature threshold, the measured APD temperature, and the selected predetermined APD temperature setting, back and forth between the system executive computer and the microcontroller via the controller.

11. A sorting apparatus as claimed in claim 10, wherein the system executive computer is configured to provide instructions to the microcontroller relating to conditions under which the microcontroller is to select a different one of the predetermined APD temperature settings.

12. A sorting apparatus as claimed in claim 10, wherein each of the plurality of predetermined APD temperature settings corresponds to a different one of the predetermined maximum ambient temperature thresholds.

13. A sorting apparatus as claimed in claim 8, wherein when the measured APD temperature differs from the selected predetermined APD temperature setting by more than an acceptable amount, the microprocessor selectively engages or disengages the heat adjustment apparatus until the measured APD temperature is within the acceptable predetermined range about the selected predetermined APD temperature setting.

14. A sorting apparatus as claimed in claim 9, wherein when the measured ambient temperature differs from the selected predetermined maximum ambient temperature threshold by more than an acceptable amount, the microprocessor selects a different one of the plurality of predetermined APD temperature settings and a different one of the predetermined maximum ambient temperature thresholds.

15. A sorting apparatus as claimed in claim 9, wherein when the measured ambient temperature is consistently below the selected predetermined maximum ambient temperature threshold by a predetermined amount for a predetermined period of time, the microprocessor selects a different one of the plurality of predetermined APD temperature settings and a different one of the predetermined maximum ambient temperature thresholds.

16. A sorting apparatus as claimed in claim 15, wherein the system executive computer is configured to provide instructions to the microcontroller relating to conditions under which the microcontroller is to select a different one of the predetermined APD temperature settings and wherein said conditions include predetermined maximum ambient temperature thresholds, predetermined APD temperature settings, and predetermined periods of time.

17. A method of using the sorting apparatus as claimed in claim 8, the method comprising:
selecting one of the plurality of predetermined APD temperature settings;
measuring the APD temperature;
comparing the measured APD temperature to the selected predetermined APD temperature setting; and
selectively engaging or disengaging the heat adjustment apparatus until the measured APD temperature is within the acceptable predetermined range about the selected predetermined APD temperature setting.

18. The method of claim 17, wherein the sorting apparatus further comprises an ambient temperature sensor configured to measure ambient temperature, and wherein the microcontroller is operably connected to the ambient temperature sensor and configured to monitor the measured ambient temperature and compare the measured ambient temperature to one of a plurality of predetermined maximum ambient temperature settings, the method further comprising:
selecting one of the plurality of predetermined maximum ambient temperature thresholds;
measuring the ambient temperature;
comparing the measured ambient temperature to the selected predetermined maximum ambient temperature setting; and
selecting a different one of the plurality of predetermined APD temperature settings and a different one of the predetermined maximum ambient temperature thresholds when the measured ambient temperature differs from the selected predetermined maximum ambient temperature setting by more than an acceptable amount; and
selecting a different one of the plurality of predetermined APD temperature settings and a different one of the predetermined maximum ambient temperature thresholds when the measured ambient temperature is consistently below the previously selected predetermined maximum ambient temperature threshold for a predetermined period of time.

19. The method of claim 18, wherein the sorting apparatus further comprises a system executive computer operably connected to the microcontroller and configured to send and receive information relating to the measured ambient temperature, the selected predetermined maximum ambient temperature threshold, the measured APD temperature, and the selected predetermined APD temperature setting, back and forth between the system executive computer and the microcontroller, wherein the method further comprises:
providing instructions to the microcontroller relating to conditions under which the microcontroller is to select a different one of the predetermined APD temperature settings and predetermined maximum ambient temperature thresholds.

20. A sorting system comprising:
two or more of the sorting apparatus as claimed in claim 7 further comprising a system executive computer operably connected to each microcontroller of the two or more sorting apparatus as claimed in claim 7, and wherein the system executive computer is configured to send and receive information relating to the measured ambient temperature, the selected predetermined maximum ambient temperature threshold, the measured APD temperature, and the selected predetermined APD temperature setting, back and forth between the system executive computer and each of the microcontrollers.
